(19) United States
(12) Patent Application Publication
(10) Pub. No.: US 2016/0018702 A1
(43) Pub. Date: Jan. 21, 2016

(54) PHOTOALIGNMENT FILM, METHOD FOR MANUFACTURING THE SAME, AND LIQUID CRYSTAL DISPLAY PANEL INCLUDING THE SAME

(71) Applicant: Samsung Display Co., Ltd., Yongin-City (KR)

(72) Inventors: Hong Yeon Lee, Seoul (KR); Suk Hoon Kang, Seoul (KR); Baek Kyun Jeon, Yongin-si (KR); Jin Soo Jung, Hwaseong-si (KR)

(21) Appl. No.: 14/550,332

(22) Filed: Nov. 21, 2014

(30) Foreign Application Priority Data
Jul. 15, 2014 (KR) 10-2014-0089134

(51) Int. Cl. G02F 1/1337; C08J 3/28; B29D 11/00; C08G 73/10

(52) U.S. Cl. CPC G02F 1/133723; C08G 73/10; C08J 3/28; B29D 11/00788; G02F 1/133788; C08J 2379/08; B29K 2077/00

(57) ABSTRACT

Provided is a photoalignment film. The photoalignment film may have a fibrous layer that is formed by stacking fibers including a photoalignment material having optical anisotropy in one direction in a state where longitudinal axes of the fibers are arranged in the one direction. The fibrous layer may have a bent surface according to a difference in stacking height between the fibers.

### CLAIM OF PRIORITY

This application is based on and claims priority from Korean Patent Application No. 10-2014-0089134, filed on Jul. 15, 2014 in the Korean Intellectual Property Office, the disclosure of which is incorporated herein in its entirety by reference.

### BACKGROUND OF THE INVENTION

1. Field of the Invention

The present invention generally relates to a photoalignment film, a method for manufacturing the same, and a liquid crystal display panel including the same, and more particularly, to a photoalighment film including stacked fibers, a method for manufacturing the same, and a liquid crystal display panel including the same.

2. Description of the Related Art

A liquid crystal display panel is one of flat display panels that have been widely used and may be configured to include two sheets of display plates on which field generating electrodes, such as a pixel electrode and a common electrode, are formed, and a liquid crystal layer interposed between the electrodes. The liquid crystal display panel can display an image by applying voltages to the field generating electrodes to generate an electric field in the liquid crystal layer, determining the direction of liquid crystals in the liquid crystal layer through the generated electric field, and controlling polarization of an incident light.

On an interior surface of the display plate, an alignment film for aligning the liquid crystals of the liquid crystal layer is formed. In the case where the electric field is not applied, the liquid crystals are arranged in a predetermined direction through the alignment film, while in the case where the electric field is applied, the liquid crystals are rotated in accordance with the direction of the electric field.

A liquid crystal alignment method is briefly classified into a contact type alignment method and a non-contact type alignment method.

The contact type alignment method is a method that gives anisotropy through direct contact with a corresponding surface. The contact type alignment method includes a rubbing method, a stamping method, and a nano-patterning method using an AFM (Atomic Force Microscope). Among them, the rubbing method has been used most widely. According to the rubbing method, polymer chains are aligned in a predetermined direction through rubbing of a substrate, on which a polyimide-based alignment film is to coated, with cotton or nylon-based cloth.

The non-contact type alignment method includes a photoalignment method and an ion beam method. Since the contact type alignment method has common problems that dust and/or static electricity may be generated due to the physical contact with the surface, the non-contact type alignment method has been spotlighted and researched as the next-generation liquid crystal alignment method.

The photoalignment method is a method that guides optical anisotropy of the surface with linearly polarized UV light irradiation on the surface using the alignment film having a photo reactor that reacts on the UV light.

### SUMMARY OF THE INVENTION

In the rubbing method, since polymer side chains are aligned in a predetermined direction, not only the alignment of the liquid crystals is adjusted by chemical interaction between the side chains and liquid crystal molecules, but also a plurality of regular grooves are generated on the surface of the alignment film through the rubbing, and thus the alignment of the liquid crystals is also adjusted by mechanical interaction between the grooves and the liquid crystals.

In contrast, according to the photoalignment method, grooves are not generated on the surface of the alignment film, but the alignment of the liquid crystals is adjusted only by the chemical reaction between a polymer layer and liquid crystals through the photoreaction. Accordingly, in comparison to the rubbing method, the photoalignment method has low anchoring energy to cause afterimages.

Accordingly, one subject to be solved by the present invention is to provide a photoalignment film having a plurality of periodic grooves on the surface using electrospinning and a method for manufacturing the same.

Another subject to be solved by the present invention is to provide a liquid crystal display including a photoalignment film that is composed of a fibrous layer where a plurality of periodic grooves are formed on the surface.

Additional advantages, subjects, and features of the invention will be set forth in part in the description which follows and in part will become apparent to those having ordinary skill in the art upon examination of the following or may be learned from practice of the invention.

In one aspect of the present invention, there may be provided a photoalignment film having a fibrous layer that is formed by stacking fibers including a photoalignment material having optical anisotropy in one direction in a state where longitudinal axes of the fibers are arranged in the one direction. The fibrous layer may have a bent surface according to a difference in stacking height between the fibers.

The longitudinal axes of the fibers may be arranged in a first direction, and the bent surface may form a concavo-convex structure of a stripe pattern that is periodically bent along a second direction that is perpendicular to the first direction.

The fiber may comprise main chains of polymer chains and side chains bonded to the main chains and aligned in the one direction.

The side chain may comprise a photoalignment material, and the photoalignment material may be at least one selected from the group including a ring type imide-based material, a cinnamate-based material, a chalcone-based material, a coumarine-based material, and an azo-based material.

In another aspect of the present invention, there may be provided a method for manufacturing a photoalignment film, comprising: forming a fibrous layer having a bent surface according to a difference in stacking height between polymer fibers through continuous spinning of the polymer fibers including a photoalignment material on a substrate; and a photoalignment step of giving optical anisotropy in one direction through irradiation of linearly polarized UV light on the fibrous layer.

The polymer fiber may be manufactured using electrospinning.

The polymer fiber may comprise main chains of polymer chains and side chains bonded to the main chains and aligned in the one direction.

The side chain may comprise a photoalignment material, and the photoalignment material may be at least one selected from the group including a photo dimerization material, a photo isomerization material, and a photo decomposition material.

The photo dimerization material may be a cinnamate-based material, the photo isomerization material may be an azo-based material, and the photo decomposition material may be a ring type polyimide-based material including cyclobutane dianhydride (CBDA).

The method for manufacturing a photoalignment film may further comprise performing first baking of the fibrous layer before the photoalignment; and performing second baking of the fibrous layer after the photoalignment.

In another aspect of the present invention, there may be provided a liquid crystal display panel having a liquid crystal layer interposed between a first substrate and a second substrate, and photoalignment films interposed between the first substrate and the liquid crystal layer and between the second substrate and the liquid crystal layer, wherein the photoalignment film may form a fibrous layer that is formed by stacking fibers including a photoalignment material having optical anisotropy in one direction in a state where longitudinal axes of the fibers are arranged in the one direction, a surface of the fibrous layer may have periodic grooves according to a difference in stacking height between the fibers, and liquid crystals of the liquid crystal layer may be accommodated in the periodic grooves on the surface of the fibrous layer and aligned in the one direction when an electric field is not applied.

The longitudinal axes of the fibers may be arranged in a first direction, and the periodic grooves are repeated along a second direction that is perpendicular to the first direction.

The fiber may comprise main chains of polymer chains and side chains bonded to the main chains and aligned in the one direction.

The side chain may comprise a photoalignment material, and the photoalignment material may be at least one selected from the group including a ring type imide-based material, a cinnamate-based material, a chalcone-based material, a coumarine-based material, and an azo-based material.

According to the method for manufacturing a photoalignment film according to an embodiment of the present invention, a plurality of periodic grooves can be formed on the surface. Further, according to the photoalignment film, the alignment of the liquid crystals can be adjusted by not only the chemical interaction between the photoalignment film and the liquid crystals but also the mechanical interaction between the grooves and the liquid crystals, and thus liquid crystal alignment force can be improved.

The liquid crystal display panel according to an embodiment of the present invention has the advantage that AC afterimage problems can be solved through the groove effect.

The effects according to the present invention are not limited to the contents as exemplified above, but further various effects are included in the description.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a view schematically illustrating a step of performing initial polymer fiber spinning using electrospinning according to an embodiment of the present invention;

FIG. 2 is a view schematically illustrating a step of forming a fibrous layer with polymer fibers after the initial spinning step of FIG. 1;

FIG. 3 is a cross-sectional view taken along line III-III′ of FIG. 2;

FIG. 4 is a view schematically illustrating a step of irradiating a fibrous layer with UV light after the step of forming a fibrous layer of FIG. 2;

FIG. 5 is a view schematically illustrating a bonding state of chains of a photo decomposition reaction material in a UV non-irradiation region of FIG. 4;

FIG. 6 is a view schematically illustrating a bonding state of chains of a photo decomposition reaction material in a UV irradiation region of FIG. 4;

FIG. 7 is a view schematically illustrating a liquid crystal alignment state after a fibrous layer is irradiated with UV light as illustrated in FIG. 6;

FIG. 8 is a perspective view schematically illustrating the liquid crystal alignment state of FIGS. 7; and

FIG. 9 is a cross-sectional view schematically illustrating a display region of a liquid crystal display panel according to an embodiment of the present invention.

### DETAILED DESCRIPTION OF THE INVENTION

Features of the inventive concept and methods of accomplishing the same may be understood more readily by reference to the following detailed description of preferred embodiments and the accompanying drawings. The inventive concept may, however, be embodied in many different forms and should not be construed as being limited to the embodiments set forth herein. Rather, these embodiments are provided so that this disclosure will be thorough and complete and will fully convey the concept of the inventive concept to those skilled in the art, and the inventive concept will only be defined by the appended claims.

In the drawings, the thickness of layers and regions are exaggerated for clarity. As used herein, the term “and/or” includes any and all combinations of one or more of the associated listed items.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof. Hereinafter, embodiments of the present invention will be described with reference to the accompanying drawings.

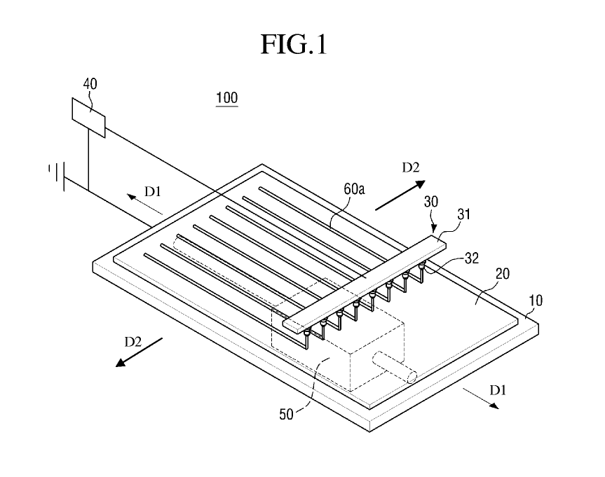

FIG. 1 is a view schematically illustrating a step of performing initial polymer fiber spinning using electrospinning according to an embodiment of the present invention. The basic principle of the electrospinning is to form continuous organic/inorganic nanofibers on a grounded lower substrate through elongation of the nanofibers in high electric fields.

Referring to FIG. 1, an electrospinning device 100 may be configured to include an electrode 10, a substrate 20, a discharge portion 30, a voltage generator 40, and a transport portion 50.

The electrode 10, which is in the form of a flat plate, may be arranged on a lower surface of the substrate 20, or may be electrically connected to the voltage generator 40.

The substrate 20 may be arranged on an upper surface of the electrode 10, and polymer fibers 60a may be stacked on the substrate 20. The substrate 20 may be a thin film transistor (TFT) substrate or a color filter (CF) substrate to be described later.

The discharge portion 30 may discharge polymer fibers 60a onto the substrate 20 through a plurality of nozzles 32 through electrospinning of a spinning solution (not illustrated), and may be arranged to be spaced apart from the substrate 20 at a predetermined interval. That is, the discharge portion 30 may be arranged to be spaced apart from an upper surface of the substrate 20 at the predetermined interval.

The discharge portion 30 may be configured to include a support substrate 31 and the plurality of nozzles 32 mounted on the support substrate 31. The plurality of nozzles 32 may be mounted on a lower surface of the support substrate 31 to be spaced apart from each other at predetermined intervals. The plurality of nozzles 32 may be arranged between the upper surface of the substrate 20 and the lower surface of the support substrate 31.

Each of the nozzles 32 may include a syringe pump (not illustrated) and an opposite electrode (not illustrated). The syringe pump pushes the spinning solution to the substrate 20, and the opposite electrode is arranged to come in contact with the spinning solution and may be connected to the voltage generator 40.

It is preferable that the spinning solution (not illustrated) has high viscosity so that the spinning solution is not intermittently discharged like droplets, but is continuously discharged. In this embodiment, the spinning solution (not illustrated) may be high-viscosity solution having viscosity of 1000 cP or more.

The spinning solution may include polymer compounds each of which is composed of main chains and side chains that are bonded to the main chains. The polymer compounds may be classified into photo decomposition polymer compounds, photo isomerization polymer compounds, and photo dimerization polymer compounds in to accordance with photoreaction materials bonded to the side chains.

The main chain may include at least one of polyimide, polyamic acid, polyamide, polyamicimide, polyester, polyethylene, polyurethane, and polystyrene. As the main chain includes more ring structures, such as imide groups, hardness of the main chain may become stronger. Accordingly, stains that may occur in the case where the liquid crystal display is operated for a long time can be reduced, and stability for pretilt of the alignment film can be heightened.

The side chain may include a photoreaction material.

The photoreaction material may be one or more selected from the group including a photo decomposition reaction material, a photo dimerization reaction material, and a photo isomerization reaction material.

The photo decomposition reaction is selective cutoff of molecular bonding in a specific direction through irradiation of linearly polarized UV light on the polymer fibers 60a. An example of the photo decomposition reaction material may be a ring type imide group material that includes cyclobutane dianhydride (CBDA), but is not limited thereto. Accordingly, all photo decomposition reaction materials known in the art may be included in the scope of the present invention.

If the linearly polarized UV light is irradiated onto the ring type imide group material including the CBDA, CBDA rings positioned in a polarization direction may be decomposed as in chemical formula 1 below. Accordingly, only a molecular bond in a direction that is perpendicular to the polarization direction remains, and thus liquid crystal molecules may be aligned along the direction that is perpendicular to the polarization direction.

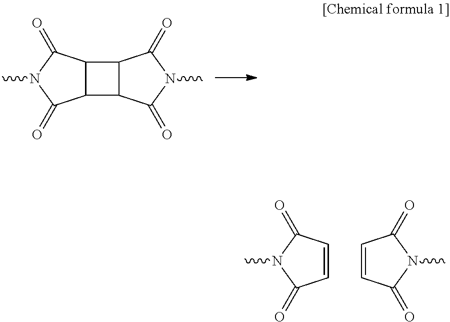

The photo dimerization reaction guides anisotropy by making molecules in the specific direction react through irradiation of linearly polarized UV light on the polymer fibers 60a. Examples of photo dimerization reaction materials may be a cinnamoyl group, a chalcone-based material, and a coumarine-based material, but are not limited thereto. Further, a representative example of the photo dimerization reaction material that includes the cinnamoyl group may be polyvinylcinnamate, but is not limited thereto. Accordingly, all polymer compounds known in the art may be included in the scope of the present invention.

In the case of irradiating the linearly polarized UV light on the photo dimerization reaction material, as indicated in chemical formula 2, the dimerization reaction occurs selectively when the direction of carbon double bond in the cinnamate-based material included in the polymer side chain coincides with the UV polarization direction. By performing linear photo dimerization with respect to the polymer that includes the cinnamate material using such characteristics, anisotropic characteristics can be given to the polymer film.

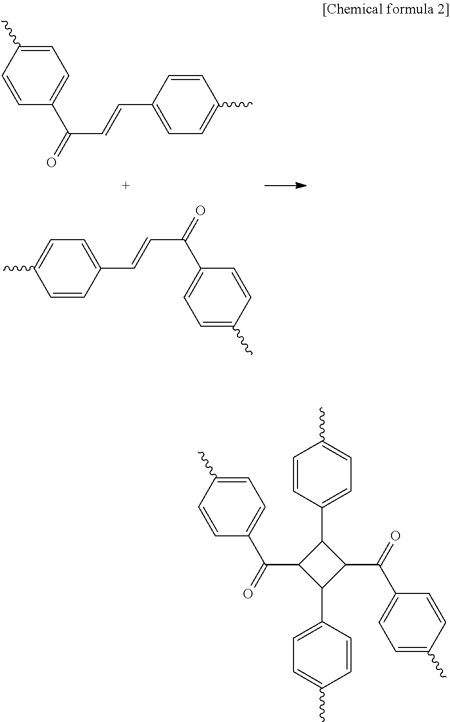

The photo isomerization reaction is to determine the alignment direction of the liquid crystal molecules by converting cis-state polymer compounds into trans-state polymer compounds or converting the trans-state polymer compounds into the cis-state polymer compounds through irradiation of the linearly polarized light on the polymer fibers 60a. In the case of the sis-state polymer compounds, the side chains are arranged in parallel to the substrate to cause the liquid crystal molecules to be homogeneously aligned on the substrate, while in the case of the trans-state polymer compounds, the side chains are vertically arranged on the substrate to cause the liquid crystal molecules to be homeotropically aligned on the substrate.

An example of a photo isomerization reaction material may be polyazobenzene, but is not limited thereto. Accordingly, all photo isomerization reaction materials known in the art may be included in the scope of the present invention.

In the case of irradiating the linearly polarized UV light on the photo isomerization reaction material, as indicated in chemical formula 3, the cis-state polyazobenzene may be isomerized to the trans-state polyazobenzene through intermediates.

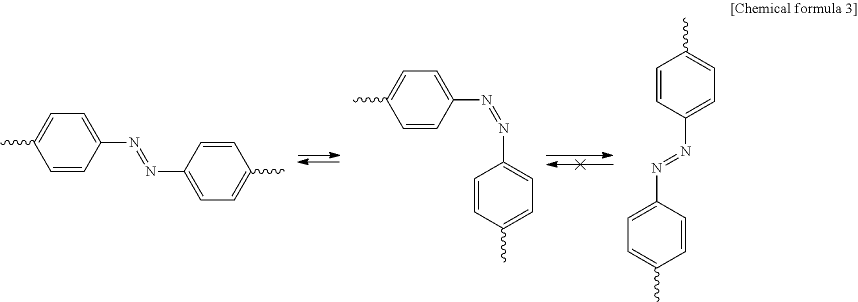

The voltage generator 40 is electrically connected to the electrode 10 and the opposite electrode of the discharge portion 30, and may be configured to apply a voltage having an opposite polarity to the polarity of the opposite electrode of the discharge portion 30.

The transport portion 50 reciprocatingly transports the electrode 10 and the substrate 20 along a predetermined transport path to make the polymer fibers 60a that are spun from the discharge portion 30 stacked along predetermined paths. In this embodiment, it is described that the transport portion 50 transports the electrode 10 and the substrate 20. However, the transport potion 50 may transport the discharge portion 30 instead of transporting the electrode 10 and the substrate 20.

The polymer fibers 60a that are spun from the plurality of nozzles 32 may be accumulated on the substrate 20 as forming line patterns in which the polymer fibers 60a are spaced apart from each other to correspond to intervals at which the plurality of nozzles 32 are spaced apart from each other.

A process in which the polymer fibers 60a in a continuously fibrous state are accumulated on the substrate 20 as forming the line patterns through the electrospinning to may be explained as follows. If a high-viscosity spinning solution is supplied to the discharge portion 30, the voltage generator 40 may apply voltages having different polarities to the electrode 10 and the opposite electrode. Due to a voltage difference between the electrode 10 and the opposite electrode, the spinning solution may be formed at the ends of the nozzles 32 as semispherical droplets. By continuous voltage applying, the spinning solution is extended in a cone shape, which is known as a Taylor cone, at the ends of the nozzles 32, and the spinning solution that is charged at threshold electric field strength may be discharged from the Taylor cone ends onto the continuous fibers. Through the process as described above, the continuous polymer fibers 60a may be discharged from the ends of the nozzles 32 to be accumulated on the substrate 20.

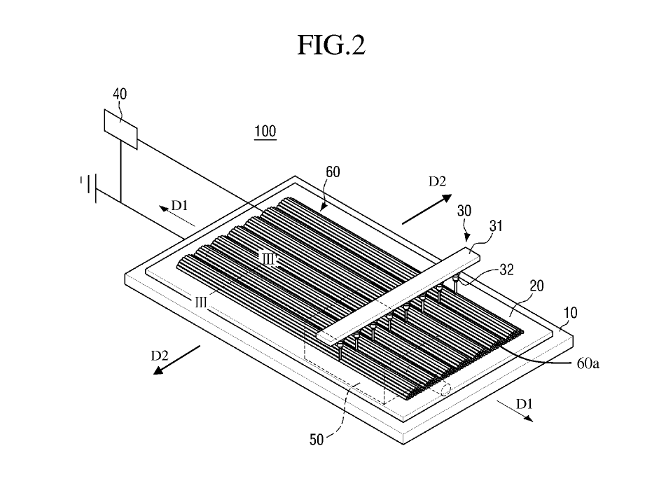

FIG. 2 is a view schematically illustrating a process of forming a fibrous layer having a bent surface as the polymer fibers 60a are stacked after the initial spinning step of FIG. 1. FIG. 2 schematically illustrates a step of forming the fibrous layer 60 through accumulation of the polymer fibers 60a as the transport portion 50 reciprocatingly transport the electrode 10 and the substrate 20 in a first direction D1 several times. The first direction D1 may be a direction in which the transport portion 50 makes the electrode 10 and the substrate 20 perform linear reciprocation.

Referring to FIG. 2, a plurality of polymer fibers 60a having longitudinal axes that are arranged in the first direction D1 may be continuously stacked on the substrate 20, and a concavo-convex structure may be formed on the surface of the fibrous layer 60 in a second direction D2 that is perpendicular to the first direction D1. That is, the surface of the fibrous layer 60 may have a bent shape in which troughs and crests alternate in the second direction D2. In other words, the surface of the fibrous layer 60 may have a concavo-convex structure of a stripe pattern in which the longitudinal axes of the plurality of polymer fibers 60a are arranged in the first direction D1 and troughs and crests are formed in the second direction D2.

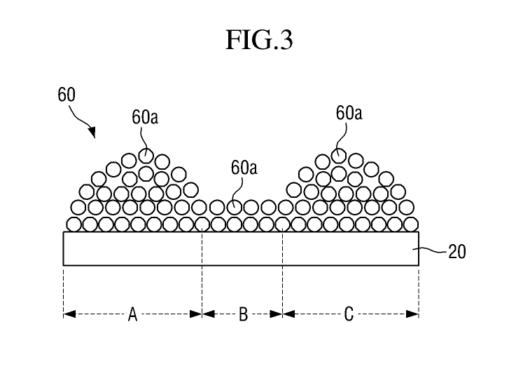

FIG. 3 is a cross-sectional view taken along line III-III′ of FIG. 2.

Referring to FIG. 3, the plurality of polymer fibers 60a in regions A and C form the crests, and the plurality of polymer fibers 60a in region B form the troughs. It may be understood that the uppermost layers of the plurality of polymer fibers 60a in region B form grooves on the basis of the upper most layers of the plurality of polymer fibers 60a in regions A and C. Further, it may be understood that the uppermost layers of the plurality of polymer fibers 60a in regions A and C form projections on the basis of the upper most layers of the plurality of polymer fibers 60a in region B. The grooves and the projections may be alternately arranged in a periodic manner along the second direction D2.

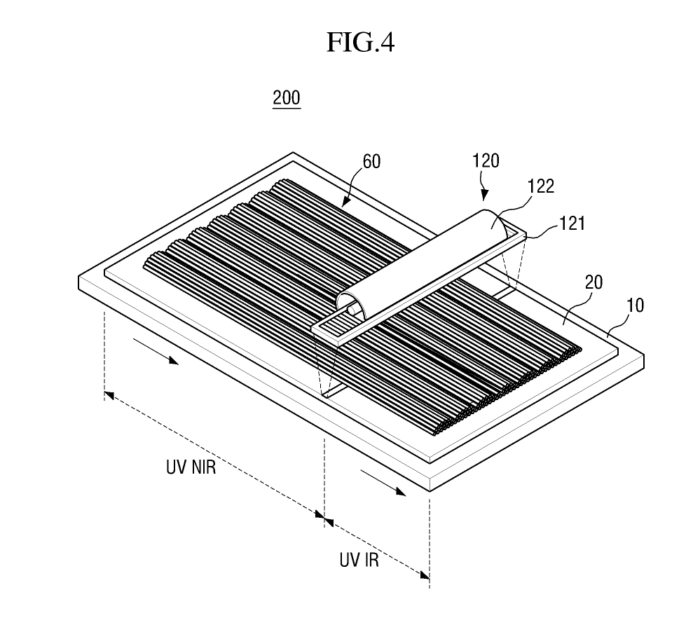

FIG. 4 is a view schematically illustrating a step of forming a photoalignment film through irradiation of UV light on a fibrous layer after the step of forming the fibrous layer of FIG. 2.

Referring to FIG. 4, a linear polarization irradiation device 200 may be configured to include a support plate 110, a substrate 20, and a light irradiation portion 120.

The support plate 110 may be a flat plate that supports the substrate 20 on which the fibrous layer 60 is formed. The support plate 110 may have an area that is larger than the area of the substrate 20 to support the substrate 20.

The substrate 20 may be a flat plate which is arranged on an upper surface of the support plate 110 and on which the fibrous layer 60 is formed.

The light irradiation portion 120 may be configured to include a lamp (not illustrated), a reflective mirror 122, and a polarizing element 121.

The lamp (not illustrated) may be a high-pressure mercury lamp that is a linear light source, or a bar-shaped lamp, such as metal halide lamp in which metal is added to mercury.

The reflective mirror 122 may be in a trough shape that reflects light from the lamp (not illustrated). The reflective mirror 122 may be configured to surround the lamp (not illustrated), and may reflect the light, which is emitted from the lamp (not illustrated) to an upper portion, to the fibrous layer 60.

The polarizing element 121 is to make linear polarization, and may be a linear lattice polarizing element. The light that is emitted from the lamp (not illustrated) or reflected from the reflective mirror 122 may be changed to a linearly polarized light

The linearly polarized light may be incident to the fibrous layer 60 to provide optical anisotropy to the fibrous layer 60 through the photo decomposition reaction, the photo dimerization reaction, or the photo isomerization reaction as described above.

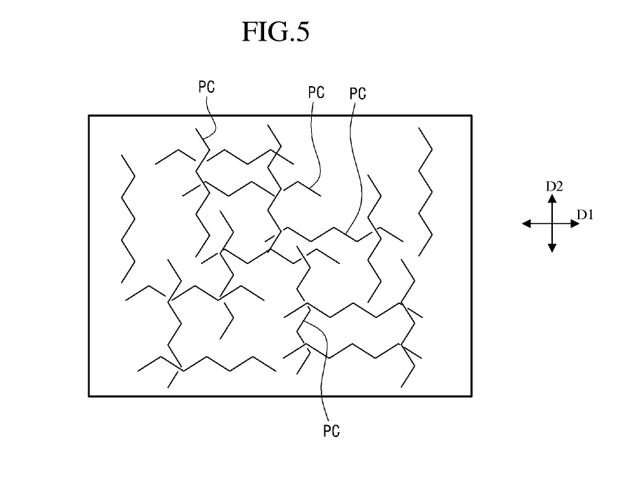

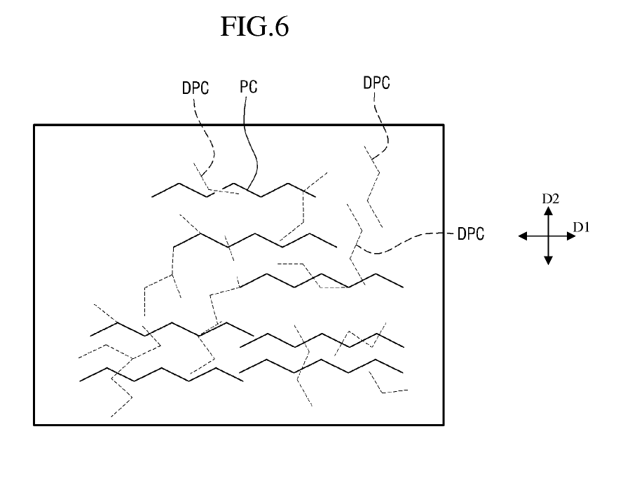

FIG. 5 is a view schematically illustrating a bonding state of chains of a photo decomposition reaction material in a UV non-irradiation region UVNIR of FIG. 4, and FIG. 6 is a view schematically illustrating a bonding state of chains of a photo decomposition reaction material in a UV irradiation region UVIR of FIG. 4.

Referring to FIG. 5, in the UV non-irradiation region UVNIR which is a region prior to exposure to linearly polarized UV light, all chains PC of the photo decomposition reaction material may be randomly arranged in a non-decomposition state. This means that the photo decomposition reaction does not occur in the UV non-irradiation region UVNIR.

Referring to FIG. 6, in the UV irradiation region UVIR which is a region after exposure to linearly polarized UV light, chains PC of the photo decomposition reaction material which are aligned in the first direction D1 that is substantially perpendicular to the polarization direction are maintained in a non-decomposition state, but chains PC of the photo decomposition reaction material which are aligned in a direction that is substantially parallel to the polarization direction are decomposed and converted to chains DPC.

As an example, in the case where the photo decomposition reaction material is a ring type imide group material including CBDA, a CBDA ring that is aligned in the direction that is substantially parallel to the polarization direction may be decomposed. In contrast, a CBDA ring that is aligned in the direction that is substantially perpendicular to the polarization direction may not be decomposed. In the case where the photo decomposition reaction material is a ring type imide group material including the CBDA, the ring type imide group material may exist in the side chain after the UV irradiation.

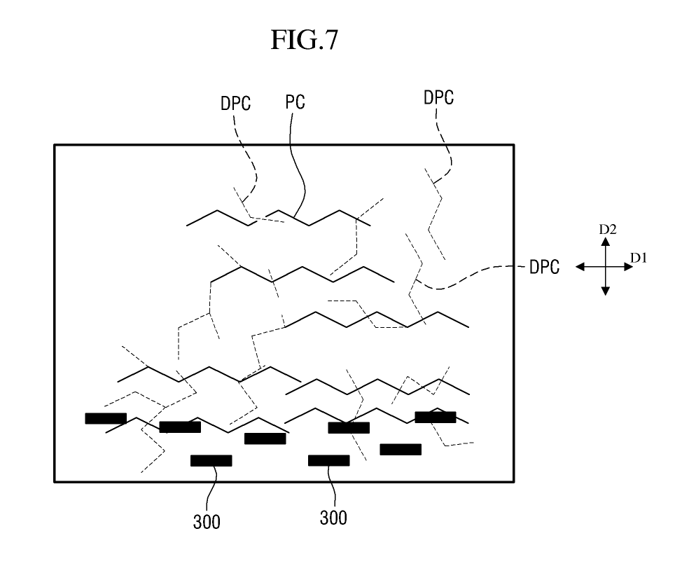

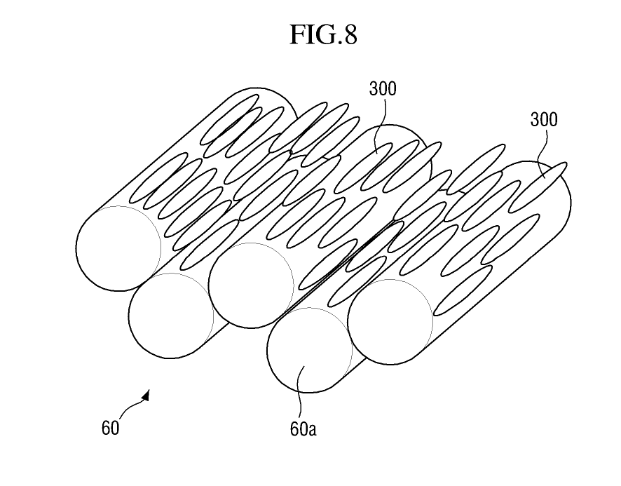

FIG. 7 is a view schematically illustrating an alignment state of liquid crystals 300 after a fibrous layer 60 is irradiated with UV light as illustrated in FIG. 6, and FIG. 8 is a perspective view schematically illustrating the alignment state of liquid crystals 300 of FIG. 7.

Referring to FIG. 7, through chemical bonding with the chains PC aligned in the first direction D1 that is substantially perpendicular to the polarization direction, liquid crystals 300 may be aligned in the first direction D1 that is the same as the alignment direction of the chains PC. Accordingly, the fibrous layer 60 can have optical anisotropy that the liquid crystals 300 are aligned in the first direction D1 that is perpendicular to the polarization direction.

The methods of using linearly polarized light to provide optical anisotropy to the fibrous layer 60 through the photo dimerization reaction with photo dimerization reaction materials or the photo isomerization reaction with photo isomerization reaction material are similar to the aforementioned method of using linearly polarized light to provide optical anisotropy to the fibrous layer 60 through the photo decomposition reaction with photo decomposition reaction materials, and thus their description will be omitted.

Referring to FIG. 8, the photoalignment film according to an embodiment of the present invention includes the fibrous layer 60 having a bent surface as a plurality of polymer fibers 60a are stacked as described above, and thus the liquid crystals 300 may be arranged along the bent surface of the fibrous layer 60.

Accordingly, unlike the photoalignment film that is manufactured using the photoalignment method in the related art, the photoalignment film according to an embodiment of the present invention can have a groove effect that improves the alignment force of the liquid crystals through the mechanical interaction between the grooves and the liquid crystals as in the rubbing alignment method.

In addition, since the photoalignment film according to an embodiment of the present invention includes the fibrous layer by stacking a plurality of polymer fibers 60a, the photoalignment film is flexible in comparison to the photoalignment film in the related art that is composed of a polymer film. Accordingly, the photoalignment film according to an embodiment of the present invention has superior utility as an alignment film for a flexible display.

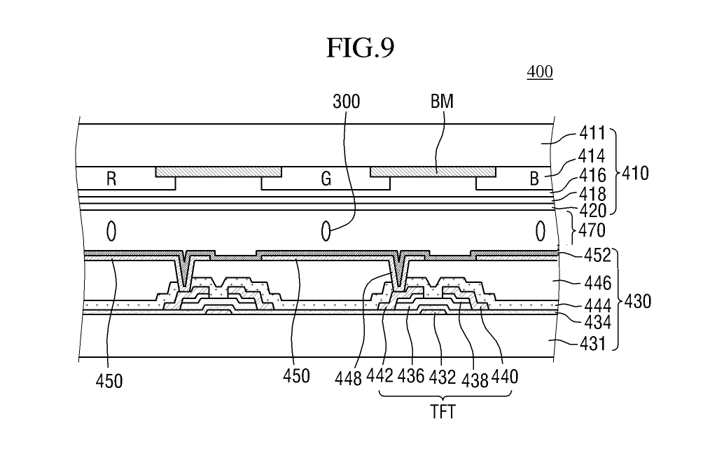

FIG. 9 is a cross-sectional view schematically illustrating a part of a display region of a liquid crystal display panel 400 according to an embodiment of the present to invention.

Referring to FIG. 9, a liquid crystal display panel 400 according to an embodiment of the present invention may include a color filter substrate 410, a thin film transistor substrate 430 that is opposite to the color filter substrate 410, and a liquid crystal layer 470 interposed between the two substrates 410 and 430.

The color filter substrate 410 may be configured to include a first light permeable substrate 411, a color filter layer 414, an overcoat layer 416, a common electrode 418, and a first alignment film 420.

The first light permeable substrate 411 may be made of a transparent material. For example, the first light permeable substrate 411 may be made of glass.

On the first light permeable substrate 411, black matrices BM that are patterned to be spaced apart from each other by a predetermined distance may be provided. The black matrices may be provided in regions that correspond to a thin film transistor TFT of the thin film transistor substrate 430, a gate line (not illustrated), and a data line (not illustrated). Further, the black matrices may be provided between the color filter layers 414 to prevent color mixture between the color filter layers 414.

The black matrices may be made of metal, and may be made of, for example, Cr, CrOx, or a double layer thereof.

Between the black matrices, red (R), green (G), and blue (B) color filter layers 414 that filter light of specific wavelength bands may be provided. The color filter layers 414 may include acryl resin and pigment. The color filter layers 414 may be discriminated as red (R), green (G), and blue (B) color filter layers depending on the kind of pigments implementing colors.

The overcoat layer 416 may be additionally provided on the black matrices and the color filter layers 414. The overcoat layer 416 is provided for protection of the color filter layers 414, surface planarization, and improvement of adhesive force with the common electrode 418.

The common electrode 418 may be provided on the overcoat layer 416. The common electrode 418 may be formed of a transparent conductive material. For example, the common electrode 418 may be made of ITO (Indium Tin Oxide) or IZO (Indium Zinc Oxide). On the common electrode 418, a first alignment film 420 may be provided to easily guide the alignment of the liquid crystals.

On the common electrode 418, a first photoalignment film 420 according to an embodiment of the present invention may be provided.

Although not illustrated in the drawing, on the color filter substrate 410, a spacer (not illustrated) that serves to keep a predetermined cell gap between the color filter substrate 410 and the thin film transistor substrate 430 may be additionally provided. In general, the spacer may be made of resin among organic polymer materials.

The thin film transistor substrate 430 may be configured to include a second light permeable substrate 431, a thin film transistor TFT, a first insulating layer 444, a second insulating layer 446, a pixel electrode 450, and a second photoalignment film 452 according to an embodiment of the present invention.

The second light permeable substrate 431 may be made of a transparent material. For example, the second light permeable substrate 431 may be made of glass.

On a display region of the second light permeable substrate 431, a thin film transistor TFT that includes a gate electrode 432, a semiconductor layer 436, an ohmic contact layer 438, a source electrode 440, and a drain electrode 442 may be formed. The thin film transistor TFT is a switching element that applies or intercepts a signal to the liquid crystals.

Specifically, the gate electrode may be made of a conductive material, such as metal. For example, the gate electrode 432 may be made of at least one selected from the group including aluminum (Al), an aluminum alloy such as aluminum-neodymium alloy (AlNd), tungsten (W), chrome (Cr), titanium (Ti), and molybdenum (Mo).

A gate insulating layer 434 may be provided between the gate electrode 432 and the semiconductor layer 436. The gate insulating layer 434 may extend onto the second light permeable substrate 431. The gate insulating layer 434 may be made of silicon oxide (SiO₂).

The semiconductor layer 436 is provided on the gate insulating layer 434 that corresponds to the gate electrode 432, and may be mad of pure amorphous silicon (a-Si:H). The ohmic contact layer 438 is provided on the semiconductor layer 436, and may be made of amorphous silicon into which an impurity is injected (n+a-Si:H). A part of the surface of the semiconductor layer 436 is exposed by the ohmic contact layer 438.

The source electrode 440 and the drain electrode 442 may be provided on the ohmic contact layer 438 to be spaced apart from each other. The source electrode 440 and the drain electrode 442 may be made of at least one selected from the group including molybdenum (Mo), titanium (Ti), tungsten (W), tungsten molybdenum (MoW), chrome (Cr), nickel (Ni), aluminum (Al), and an aluminum alloy such as aluminum-neodymium alloy (AlNd). In a gap section between the source 440 and the drain electrode 442, where a part of the surface of the semiconductor layer 436 is exposed, a channel (not illustrated) for conducting the source electrode 440 and the drain electrode 442 with each other may be formed.

Accordingly, if a high-level voltage is applied to the gate electrode 432 and a data voltage are applied to the source electrode 440, the data voltage that is applied to the source electrode 440 by the high-level voltage applied to the gate electrode 432 is supplied to the drain electrode 442 through the semiconductor layer 436.

Although not illustrated in the drawing, a gate line that is connected to the gate electrode 432 is provided in a third direction, and a data line that is connected to the source electrode 440 is provided in a fourth direction that crosses the third direction. A region in which the gate line and the data line cross each other is defined as a pixel region.

A first insulating layer 444 and a second insulating layer 446 may be provided to be stacked in order on the thin film transistor TFT. The first insulating layer 444 is to protect the thin film transistor TFT and to prevent unfitting of the second insulating layer 446, and may extend onto the gate insulating layer 434 of a non-display region. The first insulating layer 444 may be made of silicon oxide (SiO₂), silicon nitride (SiNx), or a double layer thereof.

The second insulating layer 446 is to reduce parasitic capacitance between the gate line (not illustrated) and the pixel electrode 450, and may be made of an organic material. The second insulating layer 446 may be made of a material having low dielectric constant, such as acryl resin or benzocyclobutene (BCB). The second insulating layer 446 may extend onto the first insulating layer 444 of the non-display region.

In the display region, a contact hole 448 that exposes a part of the surface of the drain electrode 442 may be provided on the second insulating layer 446 and the first insulating layer 444. On the second insulating layer 446 of the display region, the pixel electrode 450 that is electrically connected to the drain electrode 442 through the contact hole 448 may be provided. The pixel electrode 450 may be provided to a region that corresponds to the color filter layers 414. The pixel electrode 450 may be made of ITO (Indium Tin Oxide).

On the pixel electrode 450 and the second insulating layer 446, a second photoalignment film 452 may be provided to easily guide the alignment of the liquid crystals. The second photoalignment film 452 may cover the second insulating layer 446 and the pixel electrode 450.

Although not illustrated, the color filter substrate 410 and the thin film transistor substrate 430 are adhered to each other by a seal line in the non-display region. The liquid crystal layer 470 may be provided in a region where a predetermined cell gap occurs between the color filter substrate 410 and the thin film transistor substrate 430. The liquid crystal layer 470 may include the liquid crystals 300 having optical anisotropic characteristics.

When a voltage is applied to the pixel electrode 450 through the drain electrode 442 and a voltage is applied to the common electrode 418, the liquid crystal display panel 400 may display an image through driving of liquid crystal cells.

In the case of providing the optical anisotropy to the fibrous layer 60 through the photo decomposition reaction, a method for manufacturing a photoalignment film according to another embodiment of the present invention may further include performing first baking of the fibrous layer before the photoalignment, and performing second baking of the fibrous layer after the photoalignment.

At the second baking step, the photoalignment material can be rearranged through sublimation of low molecular materials after the UV irradiation. Accordingly, at the second baking step, the liquid crystal alignment force can be improved. The second baking step may be performed at a temperature that is equal to or higher than 200° C. and equal to or lower than 250° C. in a range that is equal to or longer than 25 minutes and equal to or shorter than 35 minutes.

Further, in the case of providing the optical anisotropy to the fibrous layer 60 through the photo isomerization reaction, a method for manufacturing a photoalignment film according to another embodiment of the present invention may further include performing baking after the photoalignment.

Further, in the case of providing the optical anisotropy to the fibrous layer 60 through the photo dimerization reaction, a method for manufacturing a photoalignment film according to another embodiment of the present invention may further include performing baking before the photoalignment and performing second photoalignment after the liquid crystal dispensing.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A photoalignment film, comprising:
a fibrous layer including a plurality of stacked fibers including a photoalignment material, the photoalignment material having optical anisotropy in a first direction along which longitudinal axes of the fibers are arranged,
the fibrous layer having a bent surface according to a difference in stacking height between the fibers.

2. The photoalignment film of claim 1, wherein the bent surface forms a concavo-convex structure of a stripe pattern that alternates along a second direction that is perpendicular to the first direction.

3. The photoalignment film of claim 1, wherein each fiber comprises main chains of polymer chains and side chains bonded to the main chains and aligned in the first direction.

4. The photoalignment film of claim 3, wherein the side chain comprises the photoalignment material, and the photoalignment material is at least one selected from the group consisting of a ring type imide-based material, a cinnamate-based material, a chalcone-based material, a coumarine-based material, and an azo-based material.

5. A method for manufacturing a photoalignment film, the method comprising:
forming a fibrous layer having a bent surface according to a difference in stacking height between polymer fibers through continuous spinning of the polymer fibers including a photoalignment material along a first direction on a substrate; and
providing optical anisotropy to the photoalignment material in the first direction through irradiation of linearly polarized UV light on the fibrous layer.

6. The method for manufacturing a photoalignment film of claim 5, wherein the polymer fiber is manufactured using electrospinning.

7. The method for manufacturing a photoalignment film of claim 6, wherein the polymer fiber comprises main chains of polymer chains and side chains bonded to the main chains and aligned in the first direction.

8. The method for manufacturing a photoalignment film of claim 7, wherein the side chain comprises the photoalignment material, and the photoalignment material is at least one selected from the group consisting of a photo dimerization material, a photo isomerization material, and a photo decomposition material.

9. The method for manufacturing a photoalignment film of claim 8, wherein the photo dimerization material is a cinnamate-based material, the photo isomerization material is an azo-based material, and the photo decomposition material is a ring type polyimide-based material including cyclobutane dianhydride (CBDA).

10. The method for manufacturing a photoalignment film of claim 5, further comprising:
performing first baking of the fibrous layer before the photoalignment; and
performing second baking of the fibrous layer after the photoalignment.

11. A liquid crystal display panel, comprising:
a liquid crystal layer interposed between a first substrate and a second substrate;
a first photoalignment film interposed between the first substrate and the liquid crystal layer; and
a second photoalignment film interposed between the second substrate and the liquid crystal layer,
each photoalignment film forming a fibrous layer including a plurality of stacked fibers including a photoalignment material, the photoalignment material having optical anisotropy in a first direction along which longitudinal axes of the fibers are arranged, a surface of the fibrous layer having periodic grooves according to a difference in stacking height between the fibers, liquid crystals of the liquid crystal layer accommodated in the periodic grooves on the surface of the fibrous layer, and the liquid crystals aligned in the first direction when an electric field is not applied.

12. The liquid crystal display panel of claim 11, wherein the periodic grooves are repeated along a second direction that is perpendicular to the first direction.

13. The liquid crystal display panel of claim 11, wherein each fiber comprises main chains of polymer chains and side chains bonded to the main chains and aligned in the one direction.

14. The liquid crystal display panel of claim 13, wherein the side chain comprises the photoalignment material, and the photoalignment material is at least one selected from the group consisting of a ring type imide-based material, a cinnamate-based material, a chalcone-based material, a coumarine-based material, and an azo-based material.
